(19) United States
(12) Patent Application Publication
(10) Pub. No.: US 2026/0150158 A1
(43) Pub. Date: May 28, 2026

(54) HEATING ASSEMBLY

(71) Applicant: INDUSTRIAL TECHNOLOGY RESEARCH INSTITUTE, Hsinchu (TW)

(72) Inventors: Cheng-Hau CHEN, Taipei City (TW); Ching-Kai KAO, Kaohsiung City (TW); Jun-Yi LIN, Puzi City (TW); Shih-Hao HUA, Changhua County (TW)

(73) Assignee: INDUSTRIAL TECHNOLOGY RESEARCH INSTITUTE, Hsinchu (TW)

(21) Appl. No.: 19/080,034

(22) Filed: Mar. 14, 2025

(30) Foreign Application Priority Data
Nov. 27, 2024 (TW) 113145844

(51) Int. Cl. H05B 3/46; B29C 45/17

(52) U.S. Cl. CPC H05B 3/46; B29C 45/1782; H05B 2203/021

(57) ABSTRACT

A heating assembly configured to heat a molding barrel and including an assembling barrel, a coil isolator and a coil assembly. The assembling barrel has an outer surface and a mounting groove. The mounting groove is radially recessed from the outer surface inwards. The coil isolator is disposed in the mounting groove. The coil assembly is disposed in the mounting groove along the coil isolator and configured to heat the molding barrel. The assembling barrel defines a circumferential direction and includes first and second assembling parts. The first and second assembling parts are arranged along the circumferential direction and are detachably assembled to each other. The coil isolator includes first and second isolation parts. The first and second isolation parts are disposed on the first and second assembling parts, respectively. The first and second isolation parts are arranged along the circumferential direction and are detachably assembled to each other.

### CROSS-REFERENCE TO RELATED APPLICATIONS

All related applications are incorporated by reference. The present application is based on, and claims priority from, Taiwan (International) Application Serial Number 113145844 filed on Nov. 27, 2024, the disclosure of which is hereby incorporated by reference herein in its entirety.

### Technical Field

The disclosure relates to a heating assembly.

### Background

For example, in an injection molding apparatus, a heater is used to heat a plastic material in a molding barrel, so as to allow the plastic material to be injected out of the molding barrel in a molten state. Recently, due to the advantage of high heating efficiency, coil heaters gradually replace the traditional resistive heaters or infrared heaters used in the injection molding apparatus.

### SUMMARY

One embodiment of this disclosure provides a heating assembly configured to heat a molding barrel and including an assembling barrel, a coil isolator and a coil assembly. The assembling barrel has an outer surface and a mounting groove. The mounting groove is radially recessed from the outer surface inwards. The assembling barrel is configured to surround the molding barrel. The coil isolator is disposed in the mounting groove. The coil assembly is disposed in the mounting groove along the coil isolator and configured to heat the molding barrel. The assembling barrel defines a circumferential direction and includes a first assembling part and a second assembling part. The first assembling part and the second assembling part are arranged along the circumferential direction and are detachably assembled to each other. The first assembling part and the second assembling part together configure the outer surface and the mounting groove. The coil isolator includes a first isolation part and a second isolation part. The first isolation part and the second isolation part are disposed on the first assembling part and the second assembling part, respectively. The first isolation part and the second isolation part are arranged along the circumferential direction and are detachably assembled to each other.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a heating assembly according to a first embodiment of the disclosure;

FIG. 2 is a partially enlarged side cross-sectional view of the heating assembly taken along line 2-2 in FIG. 1;

FIG. 3 is a front view showing that the heating assembly in FIG. 1 is assembled to a molding barrel;

FIGS. 4 and 5 are perspective exploded views of a coil isolator and an assembling barrel of the heating assembly in FIG. 1;

FIG. 6 is a perspective exploded view of the assembling barrel and thermally insulating supports of the heating assembly in FIG. 1;

FIG. 7 is a partially enlarged perspective exploded view of the assembling barrel and a mounting barrel of the heating assembly in FIG. 1;

FIG. 8 is a partially enlarged view of the heating assembly in FIG. 2;

FIG. 9 is a perspective view of a heating assembly according to a second embodiment of the disclosure;

FIG. 10 is a partially enlarged side cross-sectional view of the heating assembly taken along line 10-10 in FIG. 9; and

FIG. 11 is a front view of the heating assembly in FIG. 9.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

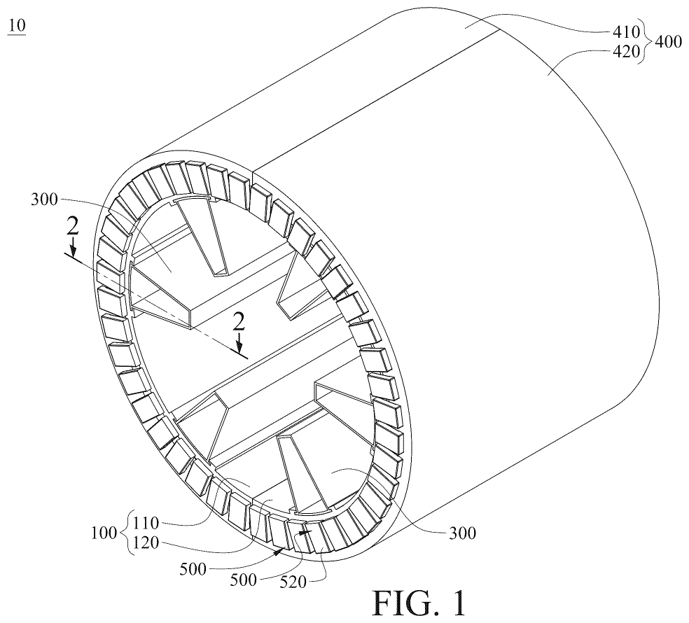

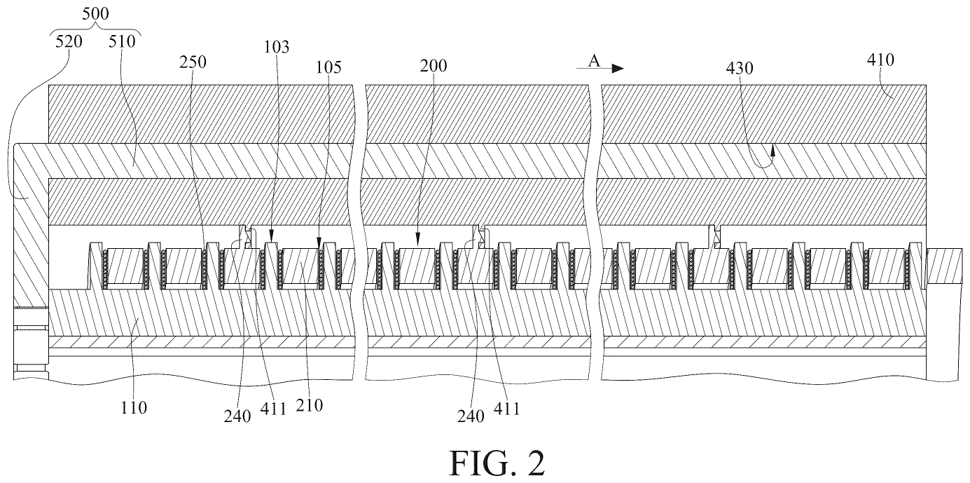

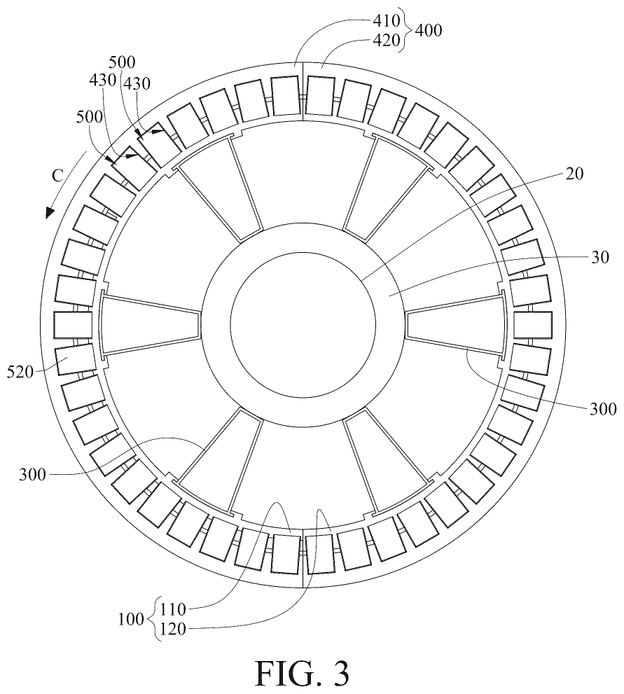

Please refer to FIGS. 1 to 3. FIG. 1 is a perspective view of a heating assembly 10 according to a first embodiment of the disclosure. FIG. 2 is a partially enlarged side cross-sectional view of the heating assembly 10 taken along line 2-2 in FIG. 1. FIG. 3 is a front view showing that the heating assembly 10 in FIG. 1 is assembled to a molding barrel 20.

In this embodiment, the heating assembly 10 is configured to heat a molding barrel 20, and includes an assembling barrel 100, a coil isolator 200, a coil assembly 250, a plurality of thermally insulating supports 300, a mounting barrel 400 and a plurality of magnets 500, where the coil isolator 200 and the coil assembly 250 are disposed on the assembling barrel 100, the thermally insulating supports 300 and the mounting barrel 400 are respectively disposed on opposite sides (e.g., an inner side and an outer side) of the assembling barrel 100, and the magnets 500 are disposed on the mounting barrel 400.

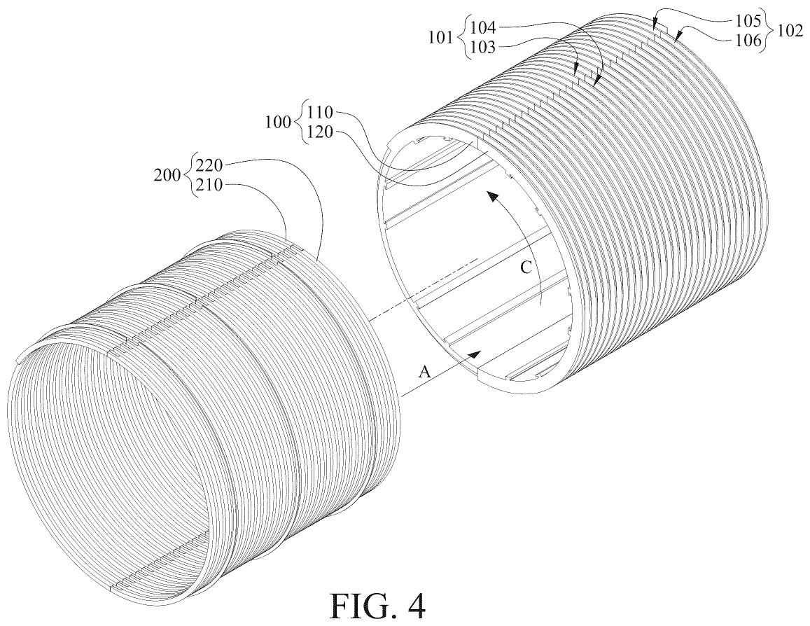

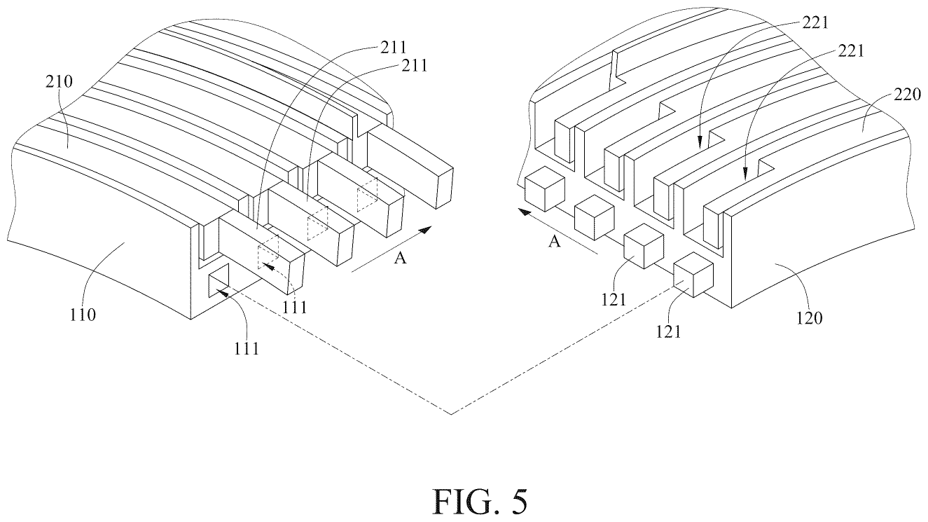

Please refer to FIGS. 2 to 5. FIGS. 4 and 5 are perspective exploded views of the coil isolator 200 and the assembling barrel 100 of the heating assembly 10 in FIG. 1. In this embodiment, the assembling barrel 100 includes a first assembling part 110 and a second assembling part 120, and has an outer surface 101 and a mounting groove 102. The assembling barrel 100 defines a circumferential direction C and an axial direction A. The first assembling part 110 and the second assembling part 120 are arranged and detachably assembled to each other along the circumferential direction C, and are configured to surround the molding barrel 20. For example, the first assembling part 110 has a plurality of first engagement structures 111 arranged along the axial direction A. The second assembling part 120 has a plurality of second engagement structures 121 arranged along the axial direction A. The first engagement structures 111 and the second engagement structures 121 are engagement recesses and engagement protrusions matching each other to form a snap-fit. The first engagement structures 111 are respectively engaged with the second engagement structures 121, so as to allow the first assembling part 110 to be detachably assembled to the second assembling part 120. The mounting groove 102 is radially recessed from the outer surface 101 inwards, and is in, for example, a spiral shape. The outer surface 101 and the mounting groove 102 are formed on the first assembling part 110 and the second assembling part 120 together. In other words, a first outer surface 103 formed on the first assembling part 110 and a second outer surface 104 formed on the second assembling part 120 together configure the outer surface 101, and a first mounting groove 105 formed on the first assembling part 110 and a second mounting groove 106 formed on the second assembling part 120 together configure the mounting groove 102.

Note that the disclosure is not limited by the configuration and number of the first engagement structures 111 and those of the second engagement structures 121. In other embodiments, there may be one first engagement structure and one second engagement structure. In other embodiments, the configuration of the first engagement structures and the configuration of the second engagement structures may be exchanged (i.e., the first engagement structures and the second engagement structures may be engagement protrusions and engagement recesses, respectively).

In this embodiment, the coil isolator 200 includes, for example, a first isolation part 210 and a second isolation part 220. The first isolation part 210 and the second isolation part 220 are disposed on the first mounting groove 105 of the first assembling part 110 and the second mounting groove 106 of the second assembling part 120, respectively. The first isolation part 210 and the second isolation part 220 are arranged and detachably assembled to each other along the circumferential direction C. For example, the first isolation part 210 has a plurality of third engagement structures 211 arranged along the axial direction A, and the second isolation part 220 has a plurality of fourth engagement structures 221 arranged along the axial direction A. The third engagement structures 211 are engaged with the fourth engagement structures 221, respectively. Also, the third engagement structures 211 and the fourth engagement structures 221 are respectively engagement protrusions and engagement recesses matching each other to form a snap-fit. Thus, the first isolation part 210 is detachably assembled to the second isolation part 220. The first isolation part 210 and the second isolation part 220 are together in, for example, a spiral shape. As shown in FIG. 2, the coil assembly 250 is disposed in the first mounting groove 105 of the first assembling part 110 along the first isolation part 210. Note that in order to prevent the complex perspective shape of the coil assembly 250 from obscuring the main point of the disclosure, the coil assembly 250 is omitted from FIGS. 4 and 5. In addition, the cross-sectional view in FIG. 2 exemplarily shows that the coil assembly 250 is disposed in the first mounting groove 105 of the first assembling part 110 along the first isolation part 210. Although not shown in the figures, it can be understood that the coil assembly 250 is disposed in the second mounting groove 106 of the second assembling part 120 along the second isolation part 220 in a similar manner. The coil assembly 250 is configured to heat the molding barrel 20. The molding barrel 20 is made by, for example, metal or other types of electrically conductive materials, and thus the molding barrel 20 is allowed to be heated by the coil assembly 250 via electromagnetic induction. For example, the molding barrel 20 may be applied in an injection molding apparatus and configured to accommodate plastic material. The coil assembly 250 is configured to heat and thus melt the plastic material accommodated in the molding barrel 20.

In this embodiment, with the design of the mounting groove 102, multiple parts of the assembling barrel 100 arranged along the circumferential direction C, and multiple parts of the coil isolator 200 arranged along the circumferential direction C, the coil assembly 250 is allowed to be mounted in the mounting groove 102 along the coil isolator 200 at a time without being wound on the assembling barrel 100 turn by turn. Thus, the time spent by assembling the coil assembly 250 to the assembling barrel 100 is saved, thereby saving the time spent by assembling the heating assembly 10 to the molding barrel 20.

Note that the disclosure is not limited by the configuration and number of the third engagement structures 211 and those of the fourth engagement structures 221. In other embodiments, there may be one third engagement structure and one fourth engagement structure. In other embodiments, the configuration of the third engagement structures and the configuration of the fourth engagement structures may be exchanged (i.e., the third engagement structures and the fourth engagement structures may be engagement recesses and engagement protrusions, respectively).

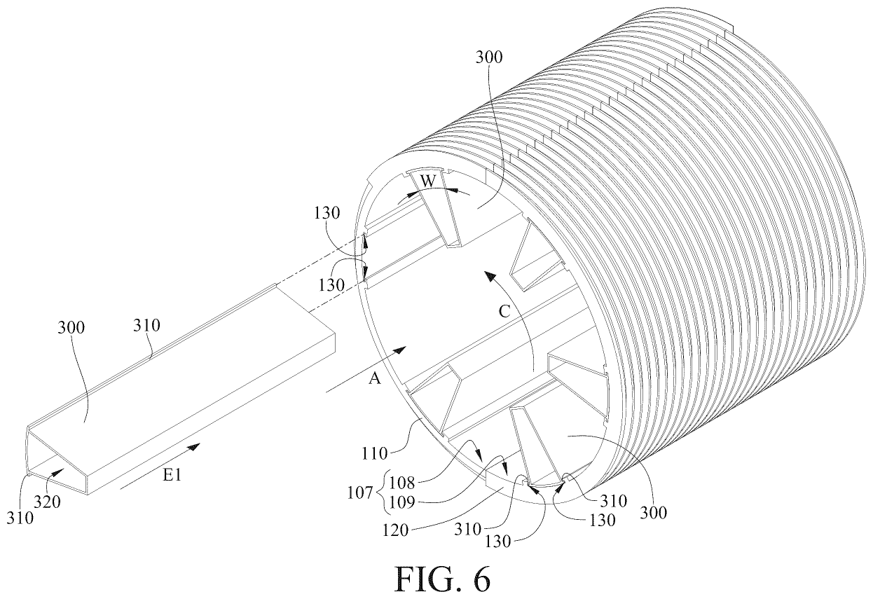

Please refer to FIGS. 3 and 6. FIG. 6 is a perspective exploded view of the assembling barrel 100 and the thermally insulating supports 300 of the heating assembly 10 in FIG. 1. The assembling barrel 100 further has an inner surface 107 facing away from the outer surface 101. The first assembling part 110 and the second assembling part 120 together configure the inner surface 107. In other words, a first inner surface 108 forming on the first assembling part 110 and a second inner surface 109 forming on the second assembling part 120 together configure the inner surface 107. The thermally insulating supports 300 are detachably mounted on the inner surface 107. For example, the assembling barrel 100 further includes a plurality of first sliding structures 130. The first sliding structures 130 are located on the first inner surface 108 and the second inner surface 109, respectively. Each thermally insulating support 300 has two second sliding structures 310 located on two opposite sides of the thermally insulating support 300, respectively. The first sliding structures 130 and the second sliding structures 310 are sliding grooves and sliders matching each other, respectively. For example, the two second sliding structures 310 of each thermally insulating support 300 are respectively engaged with two of the first sliding structures 130 that are located adjacent to and spaced part from each other, thereby allowing each thermally insulating support 300 to be slidably disposed on the inner surface 107 along the axial direction A. The thermally insulating supports 300 are arranged along the circumferential direction C and configured to surround the molding barrel 20. In addition, sides of the thermally insulating supports 300 located away from the assembling barrel 100 are configured to rest on, for example, a thermally insulating sleeve 30, and are further disposed on the molding barrel 20 via the thermally insulating sleeve 30, thereby supporting the molding barrel 20. The thermally insulating sleeve 30 is, for example, elastic.

In this embodiment, the thermally insulating supports 300 are detachably mounted on the assembling barrel 100. Thus, when the heating assembly 10 is required to be mounted on molding barrels 20 of different sizes by thermally insulating supports 300 of different sizes, the thermally insulating supports 300 are allowed to be mounted on or detached from the assembling barrel 100 more efficiently. Accordingly, the time spent by assembling the heating assembly 10 to molding barrels 20 of different sizes is saved.

In addition, in this embodiment, each thermally insulating support 300 further has, for example, a through hole 320. When the thermally insulating support 300 is mounted on the assembling barrel 100, an extension direction E1 defined by the through hole 320 is, for example, parallel to the axial direction A. With the through hole 320, a user is allowed to hold the thermally insulating support 300 in a more convenient manner, thereby facilitating the mounting or detachment of the thermally insulating support 300 relative to the thermally insulating sleeve 30. In other embodiments, the thermally insulating support may not have the through hole.

Moreover, in this embodiment, a width W of each thermally insulating support 300 in the circumferential direction C is decreased from a side of the thermally insulating support 300 located close to the inner surface 107 to a side of the thermally insulating support 300 located away from the inner surface 107. That is, each thermally insulating support 300 tapers away from the inner surface 107. Thus, the thermally insulating support 300 is stably disposed on the thermally insulating sleeve 30. In other embodiments, the width of the thermally insulating support in the circumferential direction may be constant.

In this embodiment, the heating assembly 10 includes the thermally insulating supports 300 arranged along the circumferential direction C to improve the efficiency of the mounting or detachment of the thermally insulating supports 300 relative to the assembling barrel 100, but the disclosure is not limited thereto. In other embodiments, the heating assembly may include one thermally insulating support. In such embodiments, the thermally insulating support may have a ring shape. Additionally, the disclosure is not limited by the number and configuration of the first sliding structures 130 and those of the second sliding structures 310. In other embodiments, there may be one first sliding structure and one second sliding structure, and the configuration of the first sliding structures and the configuration of the second sliding structures may be exchanged (i.e., the first sliding structures and the second sliding structures may be sliders and sliding grooves, respectively).

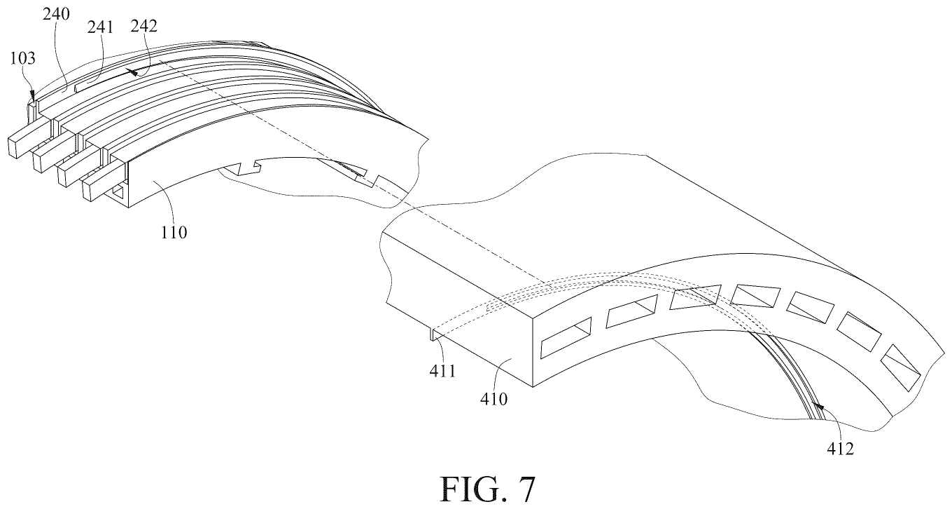

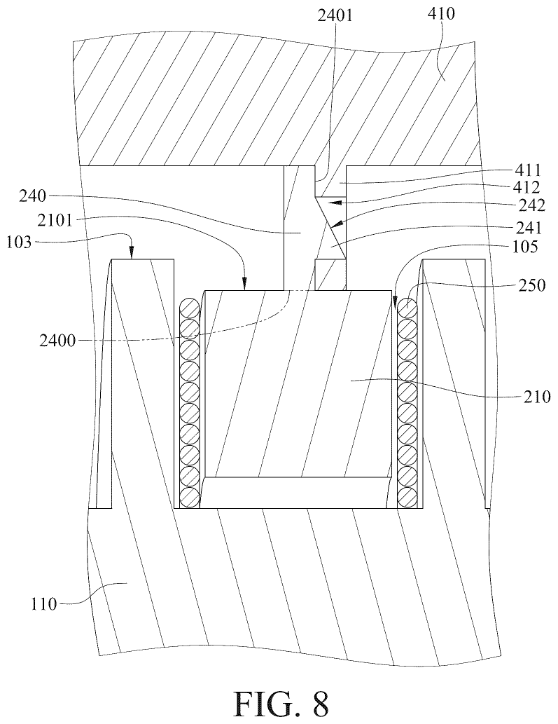

Please refer to FIGS. 2, 3, 7 and 8. FIG. 7 is a partially enlarged perspective exploded view of the assembling barrel 100 and the mounting barrel 400 of the heating assembly 10 in FIG. 1. FIG. 8 is a partially enlarged view of the heating assembly 10 in FIG. 2.

The mounting barrel 400 is detachably mounted on the assembling barrel 100 and surrounds the assembling barrel 100. For example, the mounting barrel 400 includes a first mounting part 410 and a second mounting part 420 arranged along the circumferential direction C. The first mounting part 410 and the second mounting part 420 are detachably disposed on the first assembling part 110 and the second assembling part 120 in similar manners, respectively. Thus, hereinafter, the detachable connection between the first mounting part 410 and the first assembling part 110 will be exemplarily described in detail. In detail, the first isolation part 210 and the second isolation part 220 each have a plurality of outer protruding bars 240 and a plurality of engagement protrusions 241. Hereinafter, the assembly between the first isolation part 210 and the first mounting part 410 will be exemplarily described, and similar descriptions of the assembly between the second isolation part 220 and the second mounting part 420 will be omitted. The outer protruding bar 240 protrude from an outer surface 2101 of the first isolation part 210, and each have a fixed side 2400 and an engaged side 2401 located adjacent to each other. The fixed side 2400 is connected to the outer surface 2101. The engagement protrusions 241 protrude from the engaged sides 2401 of the outer protruding bars 240, respectively. The first mounting part 410 has a plurality of inner protruding bars 411. The inner protruding bars 411 are located on a side of the first mounting part 410 located close to the first assembling part 110, and each have an engagement slot 412. The engagement protrusions 241 are respectively engaged with the engagement slots 412, so as to allow the first mounting part 410 to be detachably disposed on the first isolation part 210. In addition, in this embodiment, each engagement protrusion 241 has, for example, an inclined guiding surface 242, thereby allowing the engagement protrusion 241 to be engaged with the engagement slot 412 in a smooth manner.

Furthermore, as shown in FIG. 8, in this embodiment, the coil assembly 250 includes, for example, multiple layers of copper wires. In each first mounting groove 105, there may be, for example, ten layers of copper wires or ten bundles of copper wires, where each bundle of copper wires may include five copper wires. In other embodiments, the number of copper wires in each first mounting groove may be adjusted according to actual requirements.

Please refer back to FIGS. 2 and 3. In this embodiment, the mounting barrel 400 has, for example, a plurality of engagement holes 430. The engagement holes 430 are located on the first mounting part 410 and the second mounting part 420, respectively. The engagement holes 430 extend along the axial direction A, and are arranged along the circumferential direction C. The magnets 500 are at least partially disposed in the engagement holes 430, respectively. In detail, in this embodiment, the magnets 500 each include a first plate part 510 and a second plate part 520. The first plate parts 510 are located in the engagement holes 430, respectively. The second plate part 520 protrudes from a side of the first plate part 510 along a radial direction of the mounting barrel 400, and is located outside the engagement holes 430, but the disclosure is not limited thereto. In other embodiments, the shape of the engagement hole may be adjusted to allow the second plate part to be located therein.

In this embodiment, the magnets 500 can change the magnetic field generated by the coil assembly 250, so as to allow the coil assembly 250 to heat the molding barrel 20 more efficiently. In this embodiments, if the demand for the efficiency of heating the molding barrel is low, the heating assembly may not include the mounting barrel 400 and the magnets 500.

Other embodiments are described below for illustrative purposes. It is to be noted that the following embodiments use the reference numerals and a part of the contents of the above embodiments, the same reference numerals are used to denote the same or similar elements, and the description of the same technical contents is omitted. For the description of the omitted part, reference may be made to the above embodiments, and details are not described in the following embodiments.

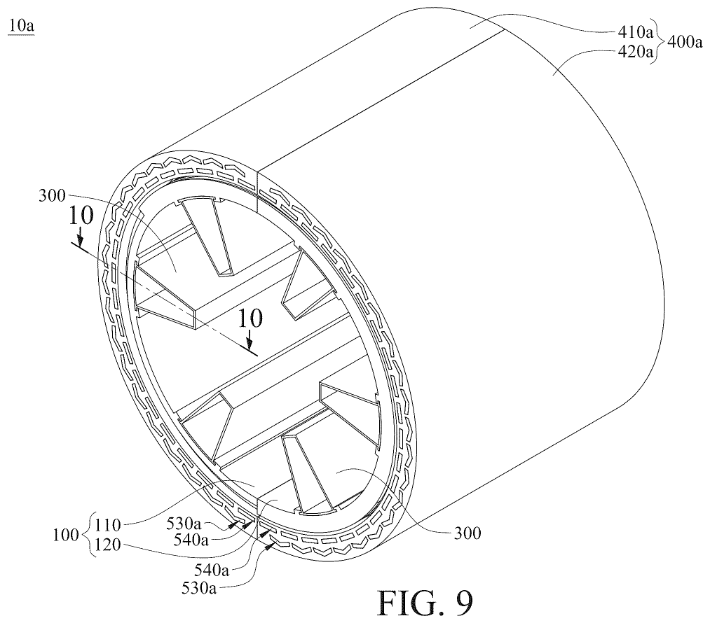

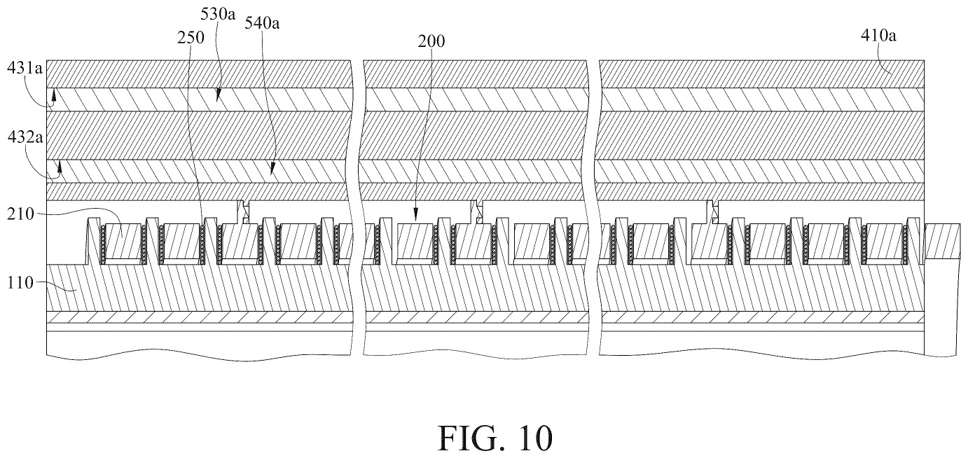

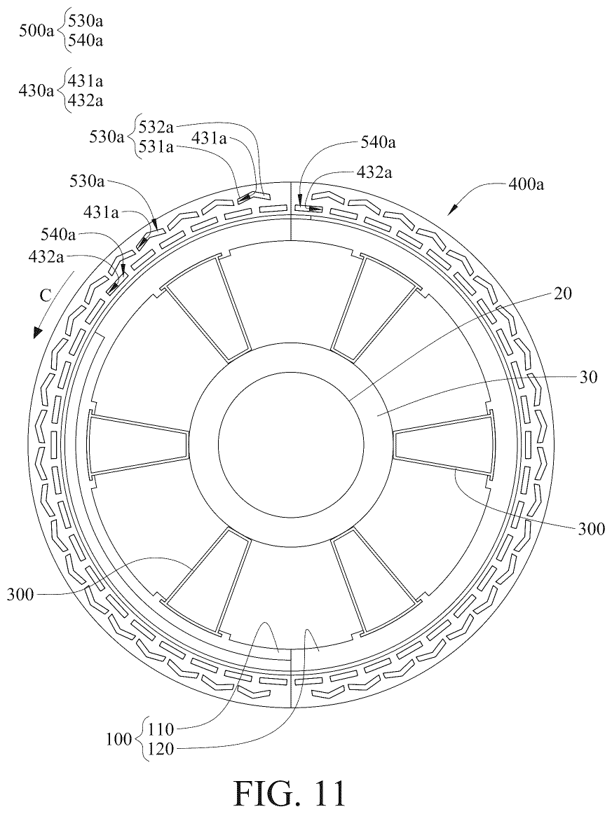

The disclosure is not limited by the configuration of the mounting barrel and that of the magnets. Please refer to FIGS. 9 to 11. FIG. 9 is a perspective view of a heating assembly 10a according to a second embodiment of the disclosure. FIG. 10 is a partially enlarged side cross-sectional view of the heating assembly 10a taken along line 10-10 in FIG. 9. FIG. 11 is a front view of the heating assembly 10a in FIG. 9. In this embodiment, the heating assembly 10a includes the assembling barrel 100, the coil isolator 200, the coil assembly 250, the thermally insulating supports 300, a mounting barrel 400a and a plurality of magnets 500a.

In this embodiment, a plurality of engagement holes 430a of the mounting barrel 400a includes a plurality of first engagement holes 431a and a plurality of second engagement holes 432a. The magnets 500a includes a plurality of first magnets 530a and a plurality of second magnets 540a. The first engagement holes 431a are arranged along the circumferential direction C. The second engagement holes 432a are arranged along the circumferential direction C, and radially spaced apart from the first engagement holes 431a. The first magnets 530a are disposed in the first engagement holes 431a, respectively. The second magnets 540a are disposed in the second engagement holes 432a, respectively. In addition, in this embodiment, the first magnet 530a includes, for example, a first plate part 531a and a second plate part 532a. The first plate part 531a and the second plate part 532a are connected and non-parallel to each other, so as to together be in a V-shape. The first plate part 531a and the second plate part 532a are located in the first engagement holes 431a. The second plate part 532a is in, for example, a plate shape.

In this embodiment, the first magnets 530a are radially located outside the second magnets 540a, but the disclosure is not limited thereto. In other embodiments, the first magnets may be radially located inside the second magnets. In this embodiment, the magnets 500a include a group of first magnets 530a and a group of second magnets 540a radially spaced apart from the group of first magnets 530a, but the disclosure is not limited thereto. In other embodiments, the magnets may include two or more groups of the first magnets 530a that are radially spaced apart from each other, or may include two or more groups of the second magnets 540a that are radially spaced apart from each other. Note that in other embodiments, the magnets may not include the first magnets 530a or the second magnets 540a.

According to the heating assembly disclosed by above embodiments, the assembling barrel has the mounting groove radially recessed from the outer surface inwards, and both of the assembling barrel and the coil isolator include multiple parts arranged along the circumferential direction (i.e., the assembling barrel includes the first assembling part and the second assembling part arranged along the circumferential direction, and the coil isolator includes the first isolation part and the second isolation part arranged along the circumferential direction). Thus, the coil assembly is allowed to be mounted in the mounting groove along the coil isolator at a time without being wound on the assembling barrel turn by turn. Thus, the time spent by assembling the coil assembly to the assembling barrel is saved, thereby saving the time spent by assembling the heating assembly to the molding barrel.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A heating assembly, configured to heat a molding barrel and comprising:
an assembling barrel, having an outer surface and a mounting groove, wherein the mounting groove is radially recessed from the outer surface inwards, and the assembling barrel is configured to surround the molding barrel;
a coil isolator, disposed in the mounting groove; and
a coil assembly, disposed in the mounting groove along the coil isolator and configured to heat the molding barrel;
wherein, the assembling barrel defines a circumferential direction and comprises a first assembling part and a second assembling part, the first assembling part and the second assembling part are arranged along the circumferential direction and are detachably assembled to each other, and the first assembling part and the second assembling part together configure the outer surface and the mounting groove; and
wherein, the coil isolator comprises a first isolation part and a second isolation part, the first isolation part and the second isolation part are disposed on the first assembling part and the second assembling part, respectively, and the first isolation part and the second isolation part are arranged along the circumferential direction and are detachably assembled to each other.

2. The heating assembly according to claim 1, wherein the first assembling part has at least one first engagement structure, the second assembling part has at least one second engagement structure, and the at least one first engagement structure and the at least one second engagement structure are protrusion and recess matching each other and are engaged with each other.

3. The heating assembly according to claim 2, wherein the first isolation part has at least one third engagement structure, the second isolation part has at least one fourth engagement structure, and the at least one third engagement structure and the at least one fourth engagement structure are protrusion and recess matching each other and are engaged with each other.

4. The heating assembly according to claim 1, wherein the mounting groove is in a spiral shape, and the first isolation part and the second isolation part are together in a spiral shape.

5. The heating assembly according to claim 1, further comprising at least one thermally insulating support, wherein the assembling barrel further has an inner surface facing away from the outer surface, the at least one thermally insulating support is detachably mounted on the inner surface of the assembling barrel, and a side of the at least one thermally insulating support located away from the assembling barrel is configured to be disposed on the molding barrel.

6. The heating assembly according to claim 5, wherein the assembling barrel further defines an axial direction and further comprises at least one first sliding structure, the at least one first sliding structure is located on the inner surface, the at least one thermally insulating support has at least one second sliding structure, the at least one first sliding structure and the at least one second sliding structure are protrusion and recess matching each other and are engaged with each other, so as to allow the at least one thermally insulating support to be slidably disposed on the inner surface of the assembling barrel along the axial direction.

7. The heating assembly according to claim 6, wherein the at least one first sliding structure and the at least one second sliding structure are sliding groove and slider, respectively.

8. The heating assembly according to claim 7, wherein the at least one first sliding structure comprises two first sliding structures and the at least one second sliding structure comprises two second sliding structures, the two first sliding structures are spaced apart from each other, and the two second sliding structures are respectively located on two opposite sides of the at least one thermally insulating support, and are respectively engaged with the two first sliding structures.

9. The heating assembly according to claim 5, wherein the assembling barrel further defines an axial direction, the at least one thermally insulating support has a through hole, and when the at least one thermally insulating support is disposed on the assembling barrel, an extension direction defined by the through hole is parallel to the axial direction.

10. The heating assembly according to claim 5, wherein a width of the at least one thermally insulating support in the circumferential direction is decreased from a side of the at least one thermally insulating support located close to the inner surface to a side of the at least one thermally insulating support located away from the inner surface.

11. The heating assembly according to claim 5, wherein the at least one thermally insulating support comprises a plurality of thermally insulating supports, and the plurality of thermally insulating supports are arranged along the circumferential direction to be configured to surround the molding barrel.

12. The heating assembly according to claim 1, further comprising a mounting barrel and at least one magnet, wherein the mounting barrel is detachably disposed on the assembling barrel and surrounds the assembling barrel, and the at least one magnet is disposed on the mounting barrel.

13. The heating assembly according to claim 12, wherein the assembling barrel further comprises an outer protruding bar and an engagement protrusion, the outer protruding bar protrudes from the outer surface and has a fixed side and an engaged side located adjacent to each other, the fixed side is connected to the outer surface, the engagement protrusion protrudes from the engaged side, the mounting barrel has an inner protruding bar, the inner protruding bar is located on a side of the mounting barrel located close to the assembling barrel and has an engagement slot, and the engagement protrusion is engaged with the engagement slot so as to allow the mounting barrel to be detachably disposed on the assembling barrel.

14. The heating assembly according to claim 13, wherein the engagement protrusion has an inclined guiding surface.

15. The heating assembly according to claim 12, wherein the assembling barrel further defines an axial direction, the mounting barrel has at least one engagement hole, the at least one engagement hole extends along the axial direction, and the at least one magnet at least partially disposed in the at least one engagement hole.

16. The heating assembly according to claim 15, wherein the at least one magnet comprises a first plate part and a second plate part, the first plate part is located in the at least one engagement hole, and the second plate part protrudes from a side of the first plate part along a radial direction defined by the mounting barrel and is located outside the engagement hole.

17. The heating assembly according to claim 15, wherein the at least one magnet comprises a first plate part and a second plate part, the first plate part and the second plate part are connected and non-parallel to each other, and the first plate part and the second plate part are located in the at least one engagement hole.

18. The heating assembly according to claim 15, wherein the at least one engagement hole comprises a plurality of engagement holes, the at least one magnet comprises a plurality of magnets, the plurality of engagement holes are arranged along the circumferential direction, and the plurality of magnets are at least partially disposed in the plurality of engagement holes, respectively.

19. The heating assembly according to claim 18, wherein the plurality of engagement holes comprise a plurality of first engagement holes and a plurality of second engagement holes, the plurality of magnets comprises a plurality of first magnets and a plurality of second magnets, the plurality of first engagement holes are arranged along the circumferential direction, the plurality of second engagement holes are arranged along the circumferential direction and radially spaced apart from the plurality of first engagement holes, the plurality of first magnets are at least partially disposed in the plurality of first engagement holes, respectively, and the plurality of second magnets are at least partially disposed in the plurality of second engagement holes, respectively.
